(19) United States
(12) Patent Application Publication
(10) Pub. No.: US 2026/0202660 A1
(43) Pub. Date: Jul. 16, 2026

(54) METHOD FOR SECURING A MEMS MICROMIRROR UNIT AND MEMS MICROMIRROR UNIT

(71) Applicant: Carl Zeiss SMT GmbH, Oberkochen (DE)

(72) Inventors: Markus HAUF, Oberkochen (DE); Hermann BIEG, Oberkochen (DE)

(21) Appl. No.: 19/564,739

(22) Filed: Mar. 12, 2026

Related U.S. Application Data
(63) Continuation of application No. PCT/EP2024/074949, filed on Sep. 6, 2024.

(30) Foreign Application Priority Data
Sep. 15, 2023 (DE) 10 2023 208 979.3

(51) Int. Cl. G02B 26/08; G02B 7/182

(52) U.S. Cl. CPC G02B 26/0833; G02B 7/1822

(57) ABSTRACT

A method secures a MEMS micromirror unit in a superordinate assembly having at least one receptacle for a MEMS micromirror unit. A MEMS micromirror unit has secured therein a superordinate assembly having at least one receptacle for a MEMS micromirror unit.

### CROSS-REFERENCE TO RELATED APPLICATIONS

The present application is a continuation of, and claims benefit under 35 USC 120 to, international application No. PCT/EP2024/074949, filed September 6, 2024, which claims benefit under 35 USC 119 of German Application No. 10 2023 208 979.3, filed September 15, 2025. The entire disclosure of each of these applications is incorporated by reference herein.

### FIELD

The disclosure relates to a method for securing a MEMS micromirror unit in a superordinate assembly having at least one receptacle for a MEMS micromirror unit, such as is used e.g. in apparatuses for semiconductor technology. The disclosure furthermore relates to a MEMS micromirror unit configured for carrying out the method.

### BACKGROUND

It is known that apparatuses for semiconductor technology are understood to be apparatuses that are used for the production or testing of microstructured component parts or the components used for this purpose. One example of such an apparatus is a photolithographic projection exposure apparatus.

Photolithography is used for producing microstructured components, such as e.g. integrated circuits. The projection exposure apparatus used in the process comprises an illumination system and a projection system. The image of a mask (also referred to as a reticle) illuminated by the illumination system is projected so as to reduce the size of the former onto a substrate, for example a silicon wafer, which is coated with a light-sensitive layer and arranged in the image plane of the projection system, using the projection system in order to transfer the mask structure to the light-sensitive coating of the substrate.

Typically, two facet mirrors are arranged in the beam path between the actual exposure radiation source and the mask to be illuminated in the case of illumination systems, such as of projection exposure apparatuses designed for the EUV range, i.e. for exposure wavelengths from 5 nm to 30 nm, and the mirrors allow homogenization of the radiation in a manner substantially comparable to the principle of a fly’s eye condenser. The closer facet mirror in the beam path of the exposure radiation source is often a so-called field facet mirror, and the other facet mirror is often a so-called pupil facet mirror.

In order to be able to produce different intensity and/or angle of incidence distributions during the illumination of the mask, it is known for the facets of at least one of the two facet mirrors – for example those of the field facet mirror – to be formed from one or more micromirrors that are electromechanically pivotable on an individual basis. The same is correspondingly disclosed e.g. in WO 2012/130768 A2.

In order to be able to achieve a small size of the individual micromirrors, it is known practice to design groups of micromirrors in the form of what is known as a MEMS mirror array, i.e. a mirror array made of microelectromechanical systems (MEMS).

In a MEMS mirror array, a multiplicity of small mirror elements are each mounted so as to be individually movable relative to a common base. For each mirror element, at least one actuator is provided and enables the mirror element to be adjusted along a respectively predefined degree of freedom. The mirror elements are frequently pivotable about two axes extending perpendicular to one another and parallel to the base, in which case enough actuators are then also provided to enable the mirror element to pivot about precisely these axes independently of one another. For the individual mirror elements, sensors can also be provided and enable the position of the mirror element to be determined relative to the base, so that the alignment of the mirrors can be monitored. An embodiment for mirrors of a MEMS mirror array is described in DE 102015204874 A1.

A method for producing a micromirror or a MEMS mirror array comprising a plurality of such micromirrors is disclosed – together with further details relating to a possible configuration of the micromirror – in DE 102015220018 A1.

In order to form a facet mirror for a projection exposure apparatus, a plurality of MEMS mirror arrays are secured to a superordinate assembly in a densely populated, planar grid arrangement. For this purpose, the MEMS mirror arrays are designed as MEMS micromirror units, which in addition to the actual MEMS mirror arrays also have an interface element as well, by which the units can be secured to the superordinate assembly.

In order that the MEMS mirror arrays can be arranged at a small distance from one another for the stated purpose of use and have the desired precise position and alignment in the inserted and secured state in the assembly, it is desirable for the individual mirror elements of a MEMS micromirror unit to be positioned and aligned with high precision relative to its interface element.

At the same time, the insertion, alignment and fixing of a MEMS micromirror unit in a superordinate assembly is to be carried out in such a way that its sensitive microelectromechanical systems are not damaged, which usually means that the microelectromechanical systems is not to be touched during mounting. Moreover, once an alignment has been effected, it is to be precisely maintained during the subsequent fixing.

### SUMMARY

The present disclosure seeks to provide an improved method for mounting MEMS micromirror units in a superordinate assembly which is improved and a corresponding MEMS micromirror unit

In an aspect, the disclosure provides a method for securing a MEMS micromirror unit in a superordinate assembly having at least one receptacle for a MEMS micromirror unit, wherein the MEMS micromirror unit comprises a MEMS mirror array structure and an interface element elongated in an axial direction, the interface element having a smaller transverse extent than the MEMS mirror array structure, so that the MEMS mirror array structure projects laterally beyond the interface element, wherein a preloading element is securable to the interface element in a predefined longitudinal position in such a way that the interface element in the state inserted into the receptacle, via the preloading element secured at the predefined longitudinal position, is axially preloaded between MEMS mirror array structure and preloading element in such a way that the MEMS micromirror unit is fixed in the receptacle, which includes:

a) introducing the MEMS micromirror unit into the receptacle;

b) aligning the MEMS micromirror unit relative to the receptacle;

c) applying to the interface element an axial tensile force greater than the subsequent preloading force;

d) securing the preloading element at the predefined longitudinal position on the interface element; and

e) removing the axial tensile force.

In an aspect, the disclosure provides a MEMS micromirror unit for securing in a superordinate assembly having at least one receptacle for a MEMS micromirror unit, wherein the MEMS micromirror unit comprises a MEMS mirror array structure projecting laterally beyond an elongated interface element, and between MEMS mirror array structure and predefined longitudinal position, an axial spring element is integrated into the interface element with a predefined spring stiffness and the interface element is suitably designed for securing a preloading element in a predefined longitudinal position thereon, so that the interface element in the state inserted into the receptacle and with a preloading element secured at the predefined longitudinal position, is axially preloaded between MEMS mirror array structure and preloading element in such a way that the MEMS micromirror unit is fixed in the receptacle.

In association with the present disclosure, “apparatus for semiconductor technology” denotes any apparatus that can be used for the production or testing of microstructured component parts or the components used for this purpose. Besides photolithographic projection exposure apparatuses, this also encompasses inspection apparatuses and metrology systems. In the case of inspection apparatuses for masks or wafers, e.g. the variability of the illumination can be increased with the aid of one or more MEMS micromirror units, which can result in higher-contrast or totally new image representations of the surface of a mask or wafer, which can be desirable for the inspection of mask or wafer. This comparably also applies to metrology systems that can be used to measure masks, wafers or any other optical elements, such as mirrors, for example, in which case an increased variability in the illumination can improve the measurement results.

The disclosure provides the insight that an interlocking fixing of a MEMS micromirror unit in a receptacle while maintaining a previously effected alignment can be achieved well if the element used for the interlocking fixing is firstly secured to the MEMS micromirror unit without any tension and only afterward is subjected to the load used for the preloading of the interlocking fixing.

A method according to the disclosure can involve a MEMS micromirror unit in which an elongated interface element is provided in addition to the actual MEMS mirror array structure, which in addition to the microelectromechanical systems which form the individual mirrors of the mirror array also comprises the carrying structures and elements for electrical connection of the microelectromechanical systems. The interface module generally extends perpendicular to the plane of the MEMS mirror array structure in which the mirrors are arranged, and has a radial extent smaller than that of the MEMS mirror array structure. In longitudinal section, the MEMS micromirror unit is thus afforded a T-shaped configuration in which the underside of the MEMS mirror array structure serves as a bearing surface or stop of the MEMS micromirror unit at the receptacle. Irrespective of whether and, if so, what mechanisms are provided for the alignment of the MEMS micromirror unit relative to the receptacle, the final fixing – even already known – can be regularly carried out by clamping the MEMS micromirror unit in the receptacle with the aid of a clamping element, such as e.g. a nut, arranged at the end of the interface module remote from the MEMS micromirror unit. However, it has been found that during the mounting of a clamping element in a previously known approach, moments acting about the longitudinal axis of the interface module or forces acting perpendicular to this longitudinal axis are regularly also introduced into the MEMS micromirror unit, and may lead to deviations from the previously performed alignment.

A method according to the disclosure can reduce this risk or even completely avoid it by virtue of the fact that introducing and aligning the MEMS micromirror unit in the receptacle is followed by firstly applying to the interface element an axial tensile force which is greater than the preloading force provided subsequently for final fixing. As a result of this axial tensile force, which effects a longitudinal extension of the interface element, the preloading element can be mounted at the intended longitudinal position on the interface element, without those axial forces acting on the preloading element which subsequently act on the preloading element on account of the preloading used for fixing the MEMS micromirror unit in the receptacle. Rather, the preloading element can generally be arranged on the interface element without any load, so that possible forces and moments that might alter the alignment of the MEMS micromirror unit can be reduced to a minimum. Not until the preloading element has been fully mounted is the axial tensile force removed – generally gradually – as a result of which the preloading force builds up between the MEMS mirror array structure and the preloading element, again without the occurrence of disturbing forces perpendicular to the longitudinal axis of the interface element or moments about that axis. The MEMS micromirror unit can maintain the initially produced alignment during fixing via a method according to the disclosure.

For carrying out the method, it is in general sufficient and also optional for the MEMS micromirror unit to be acted on exclusively at the interface element, for example in the region of the end remote from the MEMS mirror array structure. For example, holding or manipulating the MEMS micromirror unit in the region of the MEMS mirror array structure, in which the microelectromechanical systems might be touched and damaged, can be completely dispensed with in the case of the method according to the disclosure.

When applying an axial tensile force and for maintaining the preloading, an axial spring element integrated into the interface element between MEMS mirror array structure and predefined longitudinal position and having a predefined spring stiffness can be tensioned. By virtue of the interface element having a corresponding axial spring element, suitable selection of the spring constant makes it possible to ensure that longitudinal extension when applying the axial tensile force is substantially concentrated on the region of the spring element. By contrast, the region of the interface element away from the axial spring element – for example between the MEMS mirror array structure and the axial spring element – does not deform or deforms only insignificantly, so that further components can be secured to the interface element there without any problems, and without having to pay particular attention to deformation of the interface element. Moreover, the final preloading force can be predefined by selecting the spring constant together with the predefinition of the position for the preloading element. The spring element can be created by suitable cutouts in the interface element, a desired spring stiffness being able to be achieved in a targeted manner by the configuration of the cutouts and the remaining material bridges while taking into account the properties of the material used. In this case, the interface element can be configured altogether in one piece, whereby the spring element is formed from the material of the rest of the interface element. However, it is also possible for the interface element, for example in the region of the spring element, to be made of a different material than e.g. adjacent to the MEMS mirror array structure. The spring element can then still be configured as described, i.e. comprise cutouts; however, the spring stiffness can be additionally influenced by selecting the material in the region of the spring element.

If an axial spring element is provided in the interface element, it is possible that, for applying the axial tensile force, the interface element is acted on adjacent to the spring element. The preloading element, too, can be secured adjacent to the spring element, for which purpose the predefined longitudinal position is predefined accordingly. The region of the interface element proceeding from the MEMS mirror array structure beyond the axial spring element may subsequently have a short longitudinal extension. Alternatively, the region in question – even if it may move in the axial direction relative to the MEMS mirror array structure on account of the axial spring element when the axial tensile force or preloading force is applied – is inherently substantially free of axial loads as a result of the axial tensile force or preloading force and thus deformations possibly caused by these forces.

It is optional for, when securing the preloading element, there to be no contact between preloading element and receptacle. If there is no such contact, it is ensurable that any possible rotational movement of the preloading element about the longitudinal axis of the interface element in any case does not lead, on account of friction between preloading element and receptacle, to a moment about the longitudinal axis of the interface element which may negatively influence the alignment of the MEMS micromirror unit. The freedom from contact in question can be ensured by suitable selection of the spring constant of the interface element or the axial spring element thereof and/or the axial tensile force.

Furthermore, it is optional for a bayonet catch to be actuated for securing the preloading element at the predefined longitudinal position on the interface element. If the connection between preloading element and interface element is accordingly designed as a bayonet catch, introducing moments about or forces in the direction of and transversely to the longitudinal axis of the interface element when securing the preloading element at the intended longitudinal position on the interface element can be reduced to a minimum. For example, there is no flank friction as when turning a nut. With this issue possibly being accepted, a screw joint can nevertheless be provided for securing the preloading element at the predefined longitudinal position on the interface element. In this case, the screw joint can be designed and configured for low flank friction.

It is optional, for defining the angular pose around the longitudinal axis of the interface element, the MEMS micromirror unit to be engaged with a suitable toothing, for example a Hirth toothing, at the receptacle. Depending on the selected toothing, e.g. in the case of a Hirth toothing, the position of the MEMS micromirror unit relative to the receptacle can also be defined in addition to the angular pose. The toothing can be provided for example on the MEMS mirror array structure and the end face of the receptacle. A desired positioning and/or angular alignment of the MEMS micromirror unit in the inserted state with respect to the longitudinal axis of the interface element can be achieved for example by adapting the toothing on the end face of the receptacle, which for this purpose can be designed as an element which is positionable and alignable separately at the receptacle.

In order also to be able to adjust the axial position of the MEMS mirror array structure relative to the receptacle and/or the preloading force, compensating pieces can be provided between the MEMS mirror array structure and the receptacle and/or between the receptacle and the preloading element. A compensating piece between MEMS mirror array structure and the receptacle changes the position of the MEMS mirror array structure in the axial direction and can increase the preloading force by extending the distance between MEMS mirror array structure and preloading element in the fixed state. A compensating piece between receptacle and the preloading element keeps the axial position of the MEMS mirror array structure unchanged, but nevertheless increases the preloading force. It is also possible for the MEMS mirror array structure to be designed for the use of compensating pieces, so that by systematically removing compensating pieces, the position of the MEMS mirror array structure relative to the receptacle can also be changed in the other direction, and the preloading force can be reduced if appropriate.

It is possible to arrange a ring-shaped seal between MEMS micromirror unit and receptacle in such a way that the seal is pressed in sealing fashion by the preloading between MEMS micromirror unit and receptacle. The two sides of the receptacle can be sealed with respect to one another via a corresponding seal. If all MEMS micromirror units and receptacles of an assembly are configured accordingly, the two sides of the assembly can be completely sealed with respect to one another - provided that besides the receptacles themselves there are no further potential fluid channels between the two sides or these are likewise suitably sealed. If a toothing is provided at the same time, it is possible for the ring-shaped seal to be arranged radially internally in relation to the toothing. The toothing can then serve as an optical labyrinth to protect the seal from harmful radiation.

It is possible for introducing the MEMS micromirror unit into the receptacle to be carried out by a tool, which, in the initial state, can be guided through the receptacle and can be interlockingly connected to the end remote from the MEMS mirror array structure. Consequently, after connection has been effected, the MEMS micromirror unit can be safely inserted into the receptacle and aligned, without the MEMS mirror array structure having to be touched.

For explanation of the MEMS micromirror unit according to the disclosure, reference is made to the statements above.

### BRIEF DESCRIPTION OF THE DRAWINGS

The disclosure will now be described by way of example on the basis of certain embodiments with reference to the accompanying drawings, in which:

FIG. 1: shows a schematic illustration of a photolithographic projection exposure apparatus comprising MEMS micromirror units according to the disclosure;

FIGS. 2-9: show schematic illustrations of the method according to the disclosure for securing a MEMS micromirror unit according to the disclosure; and

FIG. 10: shows a schematic illustration of an embodiment variant for securing a MEMS micromirror unit according to the disclosure.

### DETAILED DESCRIPTION

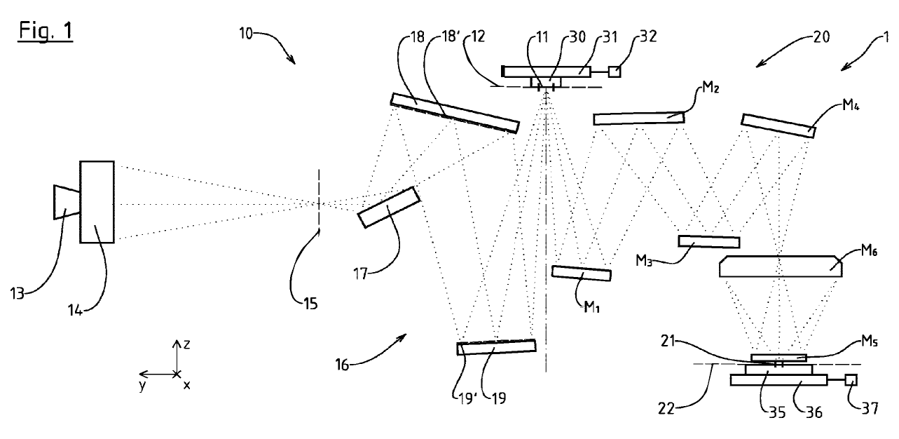

FIG. 1 illustrates a schematic meridional section through a photolithographic projection exposure apparatus 1 as an example of an apparatus for semiconductor technology. In this case, the projection exposure apparatus 1 comprises an illumination system 10 and a projection system 20.

An object field 11 in an object plane or reticle plane 12 is illuminated with the aid of the illumination system 10. For this purpose, the illumination system 10 comprises an exposure radiation source 13, which, in the illustrated exemplary embodiment, emits illumination radiation at least comprising used light in the EUV range, i.e. with a wavelength of between 5 nm and 30 nm for example. The exposure radiation source 13 can be a plasma source, for example an LPP (laser produced plasma) source or a GDPP (gas discharge produced plasma) source. It can also be a synchrotron-based radiation source. The exposure radiation source 13 can also be a free electron laser (FEL).

The illumination radiation emerging from the exposure radiation source 13 is initially focused in a collector 14. The collector 14 can be a collector with one or with a plurality of ellipsoidal and/or hyperboloidal reflection surfaces. The illumination radiation can be incident on the at least one reflection surface of the collector 14 with grazing incidence (GI), i.e. at angles of incidence of greater than 45°, or with normal incidence (NI), i.e. at angles of incidence of less than 45°. The collector 14 can be structured and/or coated on the one hand for optimizing its reflectivity for the used radiation and on the other hand for suppressing extraneous light.

Downstream of the collector 14, the illumination radiation propagates through an intermediate focus in an intermediate focal plane 15. If the illumination system 10 is constructed in a modular design, the intermediate focal plane 15 can be used, in general, for the separation – including the structural separation – of the illumination system 10 into a radiation source module, comprising the exposure radiation source 13 and the collector 14, and the illumination optics unit 16 described below. In the case of a corresponding separation, radiation source module and illumination optics unit 16 then jointly form a modularly constructed illumination system 10.

The illumination optics unit 16 comprises a deflection mirror 17. The deflection mirror 17 can be a plane deflection mirror or alternatively a mirror with a beam-influencing effect going beyond the pure deflection effect. Alternatively or additionally, the deflection mirror 17 can be embodied as a spectral filter that separates a used light wavelength of the illumination radiation from extraneous light having a wavelength that deviates therefrom.

The deflection mirror 17 is used to deflect the radiation emanating from the exposure radiation source 13 to a first facet mirror 18. If – as in the present case – the first facet mirror 18 is arranged in a plane of the illumination optics unit 16 which is optically conjugate to the reticle plane 12 as a field plane, this facet mirror is also referred to as a field facet mirror.

The first facet mirror 18 comprises a multiplicity of micromirrors 18' that are individually pivotable about two mutually perpendicular axes in each case, for the purpose of controllably forming facets which each can be configured with an orientation sensor (not illustrated) for determining the orientation of the micromirror 18'. The first facet mirror 18 is thus a microelectromechanical system (MEMS system), as also described in DE 102008009600 A1, for example.

A second facet mirror 19 is arranged downstream of the first facet mirror 18 in the beam path of the illumination optics unit 16, with the result that this yields a doubly faceted system, the fundamental principle of which is also referred to as a fly's eye integrator. If the second facet mirror 19 – as in the illustrated exemplary embodiment – is arranged in a pupil plane of the illumination optics unit 16, it is also referred to as a pupil facet mirror. However, the second facet mirror 19 can also be arranged at a distance from a pupil plane of the illumination optics unit 16, as a result of which a specular reflector arises from the combination of the first and the second facet mirror 18, 19, for example as described in US 2006/0132747 A1, EP 1614008 B1 and US 6,573,978.

The second facet mirror 19 need not in general be constructed from pivotable micromirrors but rather can comprise individual facets formed from one mirror or a manageable number of mirrors which are significantly larger than micromirrors, which facets are either stationary or tiltable only between two defined end positions. It is however – as illustrated – also possible, in the second facet mirror 19, to provide a microelectromechanical system having a multiplicity of micromirrors 19' that are individually pivotable about two mutually perpendicular axes in each case, each can comprise an orientation sensor.

The individual facets of the first facet mirror 18 are imaged into the object field 11 with the aid of the second facet mirror 19, with this regularly only being approximate imaging. The second facet mirror 19 can be the last beam-shaping mirror or else actually the last mirror for the illumination radiation in the beam path upstream of the object field 11.

In each case one of the facets of the second facet mirror 19 is assigned to exactly one of the facets of the first facet mirror 18 for the purpose of forming an illumination channel for illuminating the object field 11. This can for example result in illumination according to the Köhler principle.

The facets of the first facet mirror 18 are imaged overlaid on one another by way of a respective assigned facet of the second facet mirror 19, for the purpose of illuminating the object field 11. Here, the illumination of the object field 11 is as homogeneous as possible. It can have a uniformity error of less than 2%. Field uniformity can be achieved by overlaying different illumination channels.

By selecting the ultimately used illumination channels, which is possible without problems by way of a suitable setting of the micromirrors 18' of the first facet mirror 18, it is still possible to set the intensity distribution in the entrance pupil of the projection system 20 described below. This intensity distribution is also referred to as illumination setting. Incidentally, it may be desirable here to arrange the second facet mirror 19 not exactly in a plane that is optically conjugate to a pupil plane of the projection system 20. For example, the pupil facet mirror 19 can be arranged tilted relative to a pupil plane of the projection system 20, as is described in DE 102017220586 A1, for example.

In the arrangement of the components of the illumination optics unit 16 as illustrated in FIG. 1, however, the second facet mirror 19 is arranged in an area conjugate to the entrance pupil of the projection system 20. Deflection mirror 17 and the two facet mirrors 18, 19 are arranged tilted both vis-à-vis the object plane 12 and vis-à-vis one another in each case.

In an alternative embodiment (not illustrated) of the illumination optics unit 16, a transfer optics unit comprising one or more mirrors can additionally be provided in the beam path between the second facet mirror 19 and the object field 11. The transfer optics unit can for example comprise one or two normal-incidence mirrors (NI mirrors) and/or one or two grazing-incidence mirrors (GI mirrors). Using an additional transfer optics unit, it is possible for example to take account of different poses of the entrance pupil for the tangential and for the sagittal beam path of the projection system 20 described below.

It is alternatively possible for the deflection mirror 17 illustrated in FIG. 1 to be omitted, for which purpose the facet mirrors 18, 19 should then be suitably arranged vis-à-vis the radiation source 13 and the collector 14.

The object field 11 in the reticle plane 12 is transferred to the image field 21 in the image plane 22 with the aid of the projection system 20.

For this purpose, the projection system 20 comprises a plurality of mirrors Mᵢ, which are consecutively numbered in accordance with their arrangement in the beam path of the projection exposure apparatus 1.

In the example illustrated in FIG. 1, the projection system 20 comprises six mirrors M₁ to M₆. Alternatives with four, eight, ten, twelve or any other number of mirrors Mᵢ are likewise possible. The penultimate mirror M₅ and the last mirror M₆ each have a passage opening for the illumination radiation, as a result of which the illustrated projection system 20 is a doubly obscured optics unit. The projection system 20 has an image-side numerical aperture that is greater than 0.3 and can also be greater than 0.6 and can be for example 0.7 or 0.75.

The reflection surfaces of the mirrors Mᵢ can be in the form of freeform surfaces without an axis of rotational symmetry. However, the reflection surfaces of the mirrors Mᵢ can alternatively also be designed as aspherical surfaces with exactly one axis of rotational symmetry of the reflection surface shape. Just like the mirrors of the illumination optics unit 16, the mirrors Mᵢ can have highly reflective coatings for the illumination radiation. These reflective coatings can be designed as multilayer coatings, for example with alternating layers of molybdenum and silicon.

The projection system 20 has a large object-image shift in the y-direction between a y-coordinate of a center of the object field 11 and a y-coordinate of the center of the image field 21. This object-image shift in the y-direction can be of approximately the same order as a z-distance between the object plane 12 and the image plane 22.

For example, the projection system 20 can be designed to be anamorphic, i.e. it has different imaging scales βₓ, β_{y} in the x- and y-directions for example. The two imaging scales βₓ, β_{y} of the projection system 20 can be (βₓ, β_{y}) = (+/-0.25, /+-0.125). An imaging scale β of 0.25 corresponds here to a reduction with a ratio 4:1, while an imaging scale β of 0.125 results in a reduction with a ratio of 8:1. A positive sign in the case of the imaging scale β means imaging without image inversion; a negative sign means imaging with image inversion.

Other imaging scales are likewise possible. Imaging scales βₓ, β_{y} with the same sign and the same absolute magnitude in the x- and y-directions are also possible.

The number of intermediate image planes in the x-direction and in the y-direction in the beam path between the object field 11 and the image field 21 can be the same or different, depending on the embodiment of the projection system 20. Examples of projection systems 20 with different numbers of such intermediate images in the x-direction and y-direction are known from US 2018/0074303 A1.

For example, the projection system 20 can comprise a homocentric entrance pupil. The latter can be accessible. However, it can also be inaccessible.

A reticle 30 (also referred to as mask) arranged in the object field 11 is exposed by the illumination system 10 and transferred by the projection system 20 onto the image plane 21. The reticle 30 is held by a reticle holder 31. The reticle holder 31 is displaceable by way of a reticle displacement drive 32 for example in a scanning direction. In the exemplary embodiment illustrated, the scanning direction runs in the y-direction.

A structure on the reticle 30 is imaged onto a light-sensitive layer of a wafer 35 arranged in the region of the image field 21 in the image plane 22. The wafer 35 is held by a wafer holder 36. The wafer holder 36 is displaceable by way of a wafer displacement drive 37 for example along the y-direction. The displacement, firstly, of the reticle 30 by way of the reticle displacement drive 32 and, secondly, of the wafer 35 by way of the wafer displacement drive 37 can be synchronized with one another.

The projection exposure apparatus 1 illustrated in FIG. 1, or its illumination system 10, the above description of which reflects certain known subject matter, could be considered as distinguishable, for example, because the first and/or second facet mirror 18, 19 is in each case composed of a plurality of MEMS micromirror units 100, with the MEMS micromirror units 100 each comprising a plurality of micromirrors 18', 19'. The individual MEMS micromirror units 100 are secured on a superordinate assembly 200 in order to jointly form the facet mirrors 18, 19 schematically depicted in FIG. 1. Once the MEMS micromirror units 100 are secured in the superordinate assembly 200, provision can also be made for connecting the individual MEMS micromirror units 100 e.g. to control electronics and/or cooling circuits.

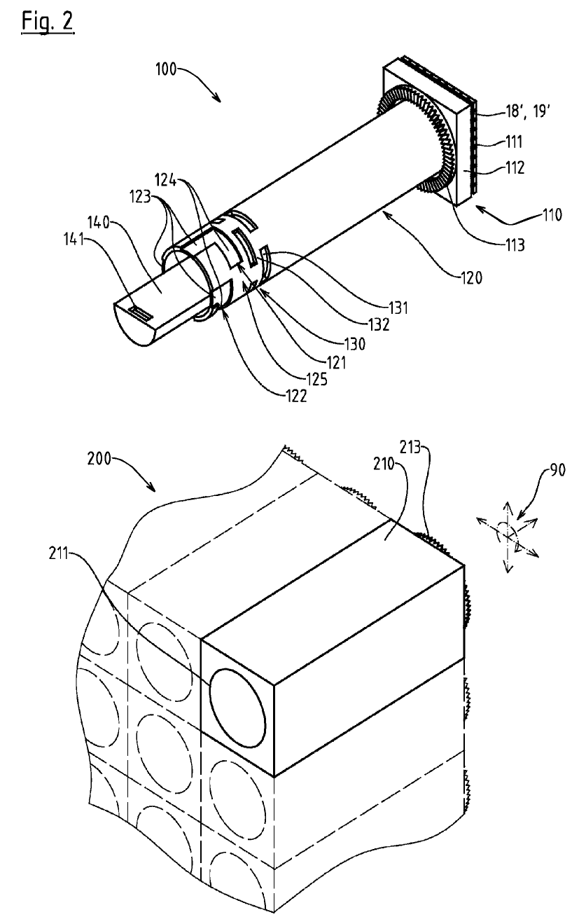

FIG. 2 schematically depicts by way of example a MEMS micromirror unit 100 and also an assembly 200, into which the MEMS micromirror unit 100 is intended to be inserted.

The MEMS micromirror unit 100 comprises a MEMS mirror array structure 110, which, in addition to the actual micromirror elements 18', 19' and the microelectromechanics 111 used for their adjustment, also has a carrying element 112 as well, which imparts the desired structural integrity and strength to the MEMS mirror array structure 110. Application-specific integrated circuits and redistribution wiring can be provided in the carrying element 110. With such redistribution wiring, the electrical contacts of the MEMS mirror array structure 111 and of the application-specific integrated circuits that are provided for operation are converted into electrical contacts to which e.g. electrical control and supply lines can be connected.

On the side facing away from the micromirror elements 18', 19', the MEMS mirror array structure 110 or the carrying element 112 has a first part 113 of a Hirth toothing 313 (cf. FIG. 4 et seq.). This first part 113 of a Hirth toothing 313 is formed in one piece with the carrying element 112 or is at least fixedly connected thereto.

An elongated interface element 120 is fixedly connected to the MEMS mirror array structure 110 and e.g. is formed in one piece with the carrying element 112 or parts thereof. The substantially rotationally symmetrical interface element 120 having a ring-shaped cross-section has a smaller transverse extent than the MEMS mirror array structure 110, so that the MEMS mirror array structure 110 projects laterally beyond the interface element 120.

At the end remote from the MEMS mirror array structure 110, the interface element 120 has slotted guides for two bayonet catches or connections 121, 122, specifically in each case two longitudinal slots 123 arranged on opposite sides of the interface element 120 with transverse slots 124 adjacent thereto. The slotted guide for one bayonet connection 121 is used for subsequently securing a preloading element 300 thereto. The configuration of the slotted guide unambiguously predefines the longitudinal position 125 for the securing of the preloading element 300.

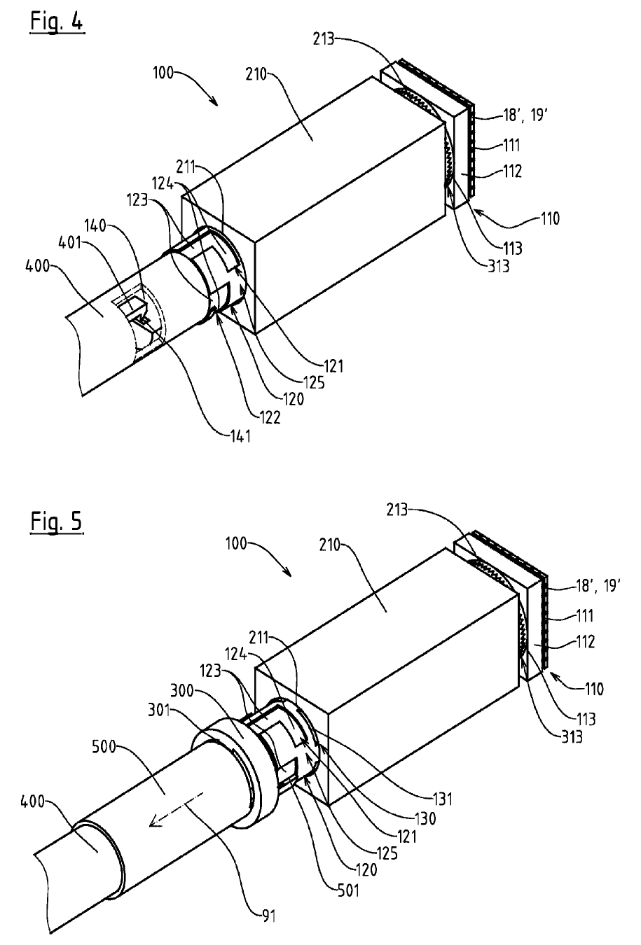

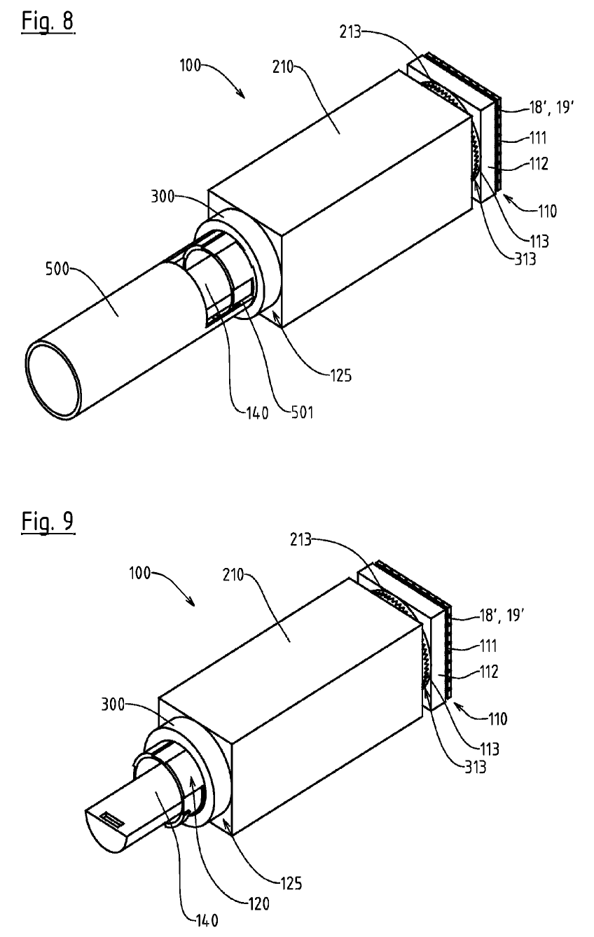

A tool 500 for applying an axial tensile force as desired can be secured to the slotted guide for the other bayonet connection 122, which will be explained in greater detail later in association with FIGS. 5 to 8.

Directly adjacent to the slotted guides for two bayonet connections 121, 122 or the predefined longitudinal position 125, an axial spring element 130 is integrated into the interface element 120. In the exemplary embodiment illustrated, the spring element 130 is created by cutouts 131 in the interface element 120, a desired spring stiffness being able to be achieved in a targeted manner by the configuration of the cutouts 131 and the remaining material bridges 132 while taking into account the properties of the material used for the interface element 120.

Arranged in the interior of the interface element 120 is a connecting element 140, which proceeding from the MEMS mirror array structure 120 projects from the interface element 120. As in the present exemplary embodiment, the connecting element 140 can be connected to the interface element 120 in the region between spring element 130 and MEMS mirror array structure 120, and the shape thereof practically does not change in the method described below either. However, it is also possible for the connecting element 140 to be secured solely to the MEMS mirror array structure 120.

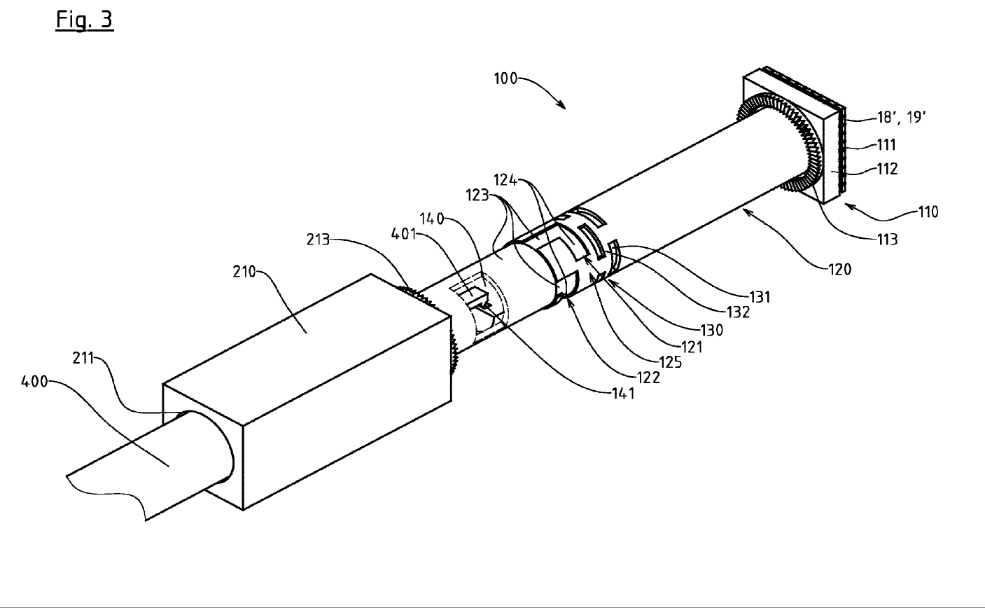

At the free end of the connecting element 140, an engagement depression 141 is provided, into which a hook element 401 can engage as desired during the method (cf. FIGS. 3 and 4). In the part of the connecting element 140 projecting from the interface element 120, it is possible to arrange electrical terminals (not illustrated), for example, via which the MEMS mirror array element 100 can be connected to a controller. Moreover, fluid connections, e.g. for a cooling medium, can be provided in the region in question of the connecting element 140. Alternatively, for this purpose, suitable lines can also be guided through the interspace between connecting element 140 and interface element 120, the interspace being present at least in the illustrated exemplary embodiment.

The superordinate assembly 200 comprises a plurality of receptacles 210, into each of which a MEMS mirror array element 100 can and is intended to be inserted. Just for reasons of clarity, exclusively one receptacle 210 will be dealt with and explained below. However, the superordinate assembly 200 generally comprises more than one receptacle 210.

The receptacle 210 is elongated, the length of the receptacle 210 in general being coordinated with the interface element 120 and for example the predefined longitudinal position 125 for the preloading element 300, as will also become clear below. The receptacle 210 furthermore comprises a rotationally symmetrical through opening 211, in which the interface element 120 of a MEMS mirror array element 100 can be received. The diameter of the through opening 211 is larger than the external diameter of the interface element 120.

In order nevertheless to be able to predefine the desired position and orientation for a MEMS mirror array element 100 to be inserted into the receptacle 210, the receptacle 210 has on one side the second part 213 of a Hirth toothing 313 (cf. FIG. 4 et seq.). This second part 213 can be finely adjusted in the degrees of freedom indicated by the arrows 90 by suitable connection to the receptacle 201 (not illustrated), wherein the adaptation in the direction of the longitudinal axis of the through opening 211 can be achieved by the provision of compensating pieces (not illustrated) between receptacle 210 and the second part 213 of a Hirth toothing 313.

With reference to FIGS. 3 to 9, an exemplary embodiment of the method according to the disclosure will now be explained, in which the MEMS micromirror unit 100 in accordance with FIG. 2 is inserted and secured in the receptacle 210 of the superordinate assembly 200.

Introducing the MEMS micromirror unit 100 into the receptacle 210, as illustrated in FIGS. 3 and 4, is carried out with the aid of a tool 400 guided through the through opening 211 of the receptacle 210, the tool butting against the interface element 120 of the MEMS micromirror unit 100 and also the inner side of the tool bearing at least partially interlockingly against the part of the connecting element 140 that projects from the interface element 120. The MEMS micromirror unit 100 is fixedly connected to the tool 400 with the aid of the hook 401, which engages into the depression 141 provided therefor on the connecting element 140.

For securing the MEMS micromirror unit 100 to the tool 400, it is sufficient to act on the MEMS micromirror unit 100 solely in the region of the interface element 120. The tool 400, too, acts solely on the interface element 120. By contrast, the MEMS mirror array structure 110 need not be touched, which significantly reduces the risk of damage, especially to the microelectromechanics 111. The MEMS mirror array structure 110 need not be touched in the subsequent steps either.

Once the MEMS micromirror unit 100 is fixedly attached to the tool 400, the interface element 120 can be introduced into the receptacle 210 by suitable movement of the tool 400 (cf. FIG. 4). It is desirable to ensure that the two parts 113, 213 are engaged in the desired pose with respect to one another, in order that the Hirth toothing 313, for which the two parts 113, 213 are provided, is thus actually formed as well. The MEMS mirror array structure 110 is then situated highly accurately in the desired position and orientation relative to the receptacle 210, as predefined by the adjustable part 213 of the Hirth toothing 313. Even if the MEMS micromirror unit 100 or its part 113 of the Hirth toothing 313 is kept engaged with the other part 213 of the Hirth toothing 313 by the tool 400, the MEMS mirror array element 100 and for example the interface element 120 and the connecting element 140 are in general free of tension.

Even if tool 400 is left connected to the MEMS micromirror unit 100 until, by the steps explained below with reference to FIG. 5, via the tool 500, the mutual engagement of the two parts 113, 213 of the Hirth toothing 313 is ensured, the way in which the tool 400 can be released from the MEMS mirror array element 100 is already depicted schematically in FIG. 4: If the hook 401 is released from the depression 141 on the connecting element 140, the tool 400 can be easily removed in the longitudinal direction.

Before the tool 400 is removed, a further tool 500, which is configured in sleeve-type fashion and can thus be pushed over the tool 400, is connected to the interface element 120. For this purpose, the tool 500 engages, by way of projections 501 provided for this purpose, into the slotted guide provided for one bayonet connection 122 in such a way that a bayonet connection 122 is created.

Afterward, an axial tensile force in the direction of the arrow 91 is exerted on the tool 500, which force is transmitted to the interface element 120 on account of the bayonet connection 122. Since this axial tensile force is greater than the subsequent preloading force, the interface element 120 elongates as a result of elastic yielding of the axial spring element 130. In the present illustration, some of the cutouts 131 of the axial spring element 130 thus become visible (cf. FIG. 5), for example, which were completely inside the receptacle 210 in the as yet unloaded state (cf. FIG. 4). It should be noted that the tensile load alone means a longitudinal extension of the axial spring element 130, but not of the connecting element 140.

Since the engagement of the two parts 113, 213 of the Hirth toothing 313 is ensured after the axial tensile force 91 has been applied, the tool 400 can then be completely removed.

The preloading element 300 has already been pushed over the tool 550. The preloading element 300 is of ring-shaped configuration and has projections 301 on its inner side, which are designed for engagement with the slotted guide of the bayonet connection 121.

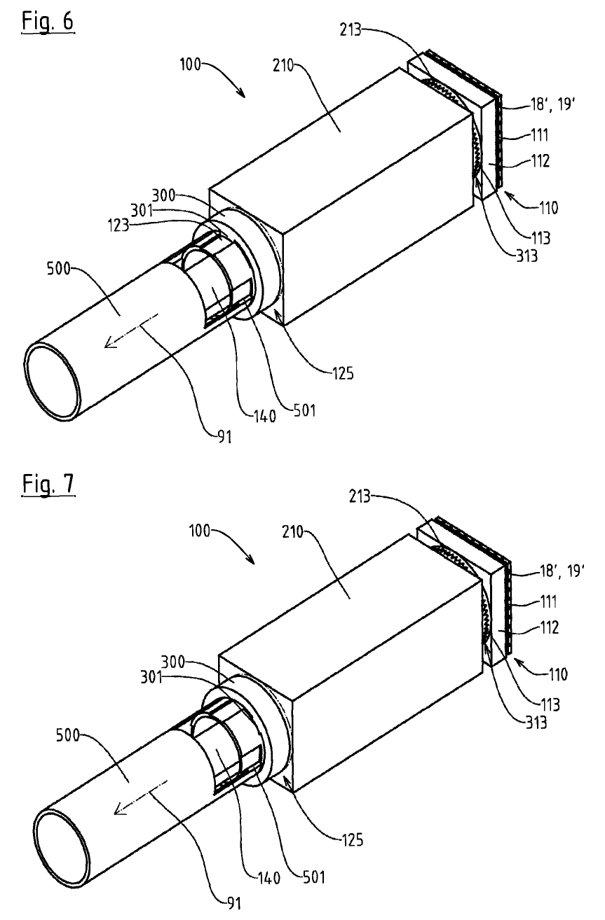

As a result of the axial tensile force 91 applied with the tool 500, the clamping element 120 or its axial spring element is stretched to an extent such that the preloading element 300 can be inserted into the longitudinal slots 123 of the slotted guide of the bayonet connection 122 without the preloading element 300 coming into contact with the receptacle 210 (cf. FIG. 6, wherein the dash-dotted line indicates the axial projection of the preloading element 300 onto the receptacle 210). If such contact cannot be avoided, at least no preloading force acts on the preloading element 300, so that the latter can be easily secured without significant mechanical interactions with the receptacle 210 occurring.

The subsequent turning of the preloading element 300, so that the projections 301 slide into the transverse slots 124 of the slotted guide of the bayonet connection 122, also ideally takes place without contact between preloading element 300 and the receptacle 210, but at least without significant mechanical interactions between receptacle 210 and preloading element 300 (cf. FIG. 7).

While the preloading element 300 is being pushed on and rotated, the axial tensile force 91 in conjunction with the Hirth toothing 313 additionally ensures that the position and orientation of the MEMS mirror array structure 110 do not change.

Once the preloading element 300 is in the position illustrated in FIG. 7, the axial tensile force 91 can be slowly reduced to zero. In this case, the longitudinal extension of the interface element 120 or of the axial spring element 130 thereof decreases until the preloading element 300 comes into contact with the receptacle 210, whereby any further reduction of the longitudinal extension is prevented. When the preloading element 300 bears against the receptacle 210, however, there is still a longitudinal extension of the interface element 120 or of the axial spring element 130 thereof by comparison with a totally tension-free state (cf. FIGS. 1 to 4).

Consequently, a preloading permanently persists, the magnitude of which is generally dependent on that of the remaining longitudinal extension and also the spring constant of the axial spring element 130. The preloading force that results at the end of the method can be predefined by suitable selection of these parameters, for example.

In order to optionally increase the preloading force – e.g. because its specification is not fully attained on account of manufacturing tolerances – it is also possible to provide a compensating piece (not illustrated) between preloading element 300 and receptacle 210, whereby the permanently remaining longitudinal extension of the interface element 120 or of the axial spring element 130 thereof is increased.

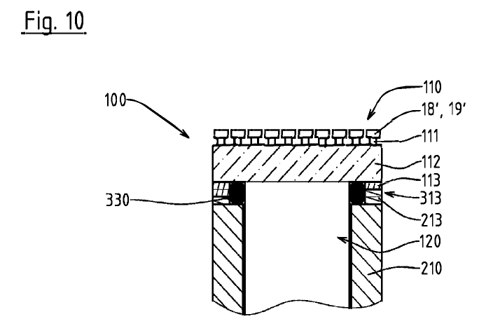

Once the axial tensile force 91 is reduced to zero, the tool 500 can be easily removed by releasing the bayonet catch 122 (cf. FIG. 9). In this case, the position and orientation of the MEMS mirror array structure 110 remain predefined by the Hirth toothing 313, wherein the preloading force produced according to the disclosure ensures that the two parts 113, 213 of the Hirth toothing 313 remain permanently engaged with one another.

FIG. 10 shows an embodiment variant for securing the MEMS micromirror unit 100, as illustrated in FIGS. 2 to 9. FIG. 10 is a schematic sectional view through the MEMS micromirror unit 100 and the receptacle 210 in the region of the Hirth toothing 313, as is also shown in the exemplary embodiment in accordance with FIGS. 2 and 9. Since, moreover, the MEMS micromirror unit 100 and the receptacle 210 are also designed substantially identically to those in FIGS. 2 and 9, reference is made to the explanations above and solely the differences in the embodiment variant are discussed below.

In the embodiment variant in accordance with FIG. 10, a ring-shaped seal 330 is arranged between MEMS micromirror unit 100 and receptacle 210 in such a way that the seal is pressed in sealing fashion by the preloading – remaining after the preloading element has been mounted – between MEMS micromirror unit 100 and receptacle 210 (cf. FIGS. 2 to 9) in such a way that the gap possibly remaining between the MEMS micromirror unit 100 and receptacle 210 is completely sealed. The seal 330 is arranged internally in regard to the Hirth toothing 313 and is protected against damage by the latter.

What is claimed is:

1. A method, comprising:
a) introducing a MEMS micromirror unit into a receptacle, the MEMS micromirror unit comprising a MEMS mirror array structure and an interface element, the interface element being elongated in an axial direction, and the interface element having a smaller transverse extent than the MEMS mirror array structure so that the MEMS mirror array structure projects laterally beyond the interface element;
b) aligning the MEMS micromirror unit relative to the receptacle;
c) applying to the interface element an axial tensile force greater than a subsequent preloading force to extend the interface element in a longitudinal direction of the interface element;
d) securing a preloading element at a predefined longitudinal position on the interface element to insert the interface element into the receptacle and to preload the interface element between the MEMS mirror array structure and the preloading element so that the MEMS micromirror unit is fixed in the receptacle; and
e) reducing and removing the axial tensile force.

2. The method of claim 1, wherein e) further comprises removing the axial tensile force.

3. The method of claim 1, wherein b) comprises acting on the MEMS micromirror unit exclusively at the interface element.

4. The method of claim 1, wherein b) comprises acting on the MEMS micromirror unit exclusively at an end region of the interface element that is remote from the MEMS mirror array structure.

5. The method of claim 1, wherein c) comprises tensioning an axial spring element with a predefined stiffness when applying the axial tensile force to maintain the preloading, an the axial spring element is integrated into the interface element between MEMS mirror array structure and the predefined longitudinal position.

6. The method of claim 4, wherein c) comprises taking action adjacent to the axial spring element and/or securing the preloading element at the predefined longitudinal position adjacent to the axial spring element.

7. The method of claim 1, wherein, during d), there is no contact between the preloading element and the receptacle.

8. The method of claim 1, wherein d) comprises actuating a bayonet catch or a screw joint to secure the preloading element at the predefined longitudinal position on the interface element.

9. The method of claim 1, further comprising, for defining an angular pose around a longitudinal axis of the interface element and/or a position relative to the longitudinal axis of the interface element, engaging the MEMS micromirror unit with a toothing at the receptacle.

10. The method of claim 8, wherein the toothing comprises a Hirth toothing.

11. The method of claim 1, further comprising providing compensating pieces to: i) define an axial position of the MEMS mirror array structure relative to the receptacle; ii) adjust a preloading force between the MEMS mirror array structure and the receptacle; and/or iii) adjust a preloading force between the receptacle and the preloading element.

12. The method of claim 1, further comprising arranging a ring-shaped seal between the MEMS micromirror unit and the receptacle so that the ring-shaped seal is pressed by preloading between MEMS micromirror unit and receptacle.

13. The method of claim 1, further comprising introducing the MEMS micromirror unit into the receptacle using a tool, which, in an initial state, is guided through the receptacle and interlockingly connected to the MEMS micromirror unit in a manner connected to an end of the interface element remote from the MEMS mirror array structure.

14. The method of claim 13, wherein b) comprises acting on the MEMS micromirror unit exclusively at the interface element.

15. A MEMS micromirror unit, comprising:
an interface element comprising an axial spring element integrated in the interface element; and
a MEMS mirror array structure projecting laterally beyond the elongated interface element,
wherein:
the axial spring element is between MEMS mirror array structure and a longitudinal position of the interface element;
the axial spring element has a spring stiffness;
the axial spring element is extendible in a longitudinal direction of the axial spring element; and
the axial spring element is configured to secure a preloading element at a longitudinal position thereon so that the interface element, when inserted into a receptacle of a superordinate assembly and with the preloading element secured at the longitudinal position, is axially preloaded between the MEMS mirror array structure and the preloading element so that the MEMS micromirror unit is fixed in the receptacle.

16. The MEMS micromirror unit of claim 15, further comprising a bayonet catch or a screw joint securing the preloading element at the predefined longitudinal position on the interface element.

17. The MEMS micromirror unit of claim 15, wherein the MEMS micromirror unit comprises a toothing defining an angular pose and/or a position in the receptacle.

18. The MEMS micromirror unit of claim 17, wherein the toothing comprises a Hirth toothing.

19. The MEMS micromirror unit of claim 15, further comprising a ring-shaped seal between MEMS micromirror unit and the receptacle so that the ring-shaped seal is pressed by the preloading between MEMS micromirror unit and receptacle.

20. An assembly, comprising:
a receptacle;
a MEMS micromirror unit configured to be secured in the receptacle, the MEMS micromirror unit comprising:
an interface element comprising an axial spring element integrated in the interface element; and
a MEMS mirror array structure projecting laterally beyond the elongated interface element; and
a preloading element,
wherein:
the axial spring element is between MEMS mirror array structure and a longitudinal position of the interface element;
the axial spring element has a spring stiffness;
the axial spring element is extendible in a longitudinal direction of the axial spring element;
the axial spring element is configured to secure the preloading element at a longitudinal position thereon so that the interface element, when inserted into the receptacle and with the preloading element secured at the longitudinal position, is axially preloaded between the MEMS mirror array structure and the preloading element so that the MEMS micromirror unit is fixed in the receptacle.
